(19) United States
(12) Patent Application Publication
(10) Pub. No.: US 2025/0071216 A1
(43) Pub. Date: Feb. 27, 2025

(54) IMAGE PROCESSING APPARATUS AND IMAGE PROCESSING METHOD

(71) Applicant: CANON KABUSHIKI KAISHA, Tokyo (JP)

(72) Inventor: ISAO MIGISHIMA, Ibaraki (JP)

(21) Appl. No.: 18/796,865

(22) Filed: Aug. 7, 2024

(30) Foreign Application Priority Data
Aug. 22, 2023 (JP) 2023-134577

(51) Int. Cl. H04N 1/00

(52) U.S. Cl. CPC H04N 1/00244

(57) ABSTRACT

An image processing apparatus includes a reception unit configured to receive a scan instruction, an acceptance unit configured to accept an instruction from a user, a scan unit configured to scan a document based on the scan instruction to generate image data, a transmission unit configured to transmit the generated image data, a setting unit configured to enable a setting requiring that the acceptance unit accepts the instruction from the user to scan the document by the scan unit based on the scan instruction, a registration unit configured to perform registration processing for the transmission unit to transmit the generated image data to a cloud server, and a display unit configured to display information for urging the user to enable the setting based on that the registration processing is performed.

### BACKGROUND

### Field

The present disclosure relates to an image processing apparatus and an image processing method.

### Description of the Related Art

Japanese Patent Application Laid-open No. 2016-19061 discusses a technique of uploading, to a cloud environment, image data generated by an image reading apparatus reading an image, and operating the uploaded image data from an information processing terminal such as a smartphone.

In a case where an image processing apparatus scans a document based on a scan instruction from an image processing apparatus such as a personal computer (PC), and transmits the generated image data to the PC, it may be possible to restrict the image processing apparatus to perform scanning in response to the scan instruction only when the image processing apparatus is in an online state. A switching from an online state to an offline state may be performed by a user manually instructing the switching, or automatically performed when the image processing apparatus receives a scan instruction from a PC. In other words, in order for the image processing apparatus to receive a scan instruction to perform scanning, there are a case where the image processing apparatus requires a user's operation and a case where the image processing apparatus does not require the user's operation. In a case where the image processing apparatus is set not to require the user's operation on the image processing apparatus to receive a scan instruction and perform scanning, there may be a possibility that a document (e.g., document placed by anyone else) not intended by the user is scanned, and the obtained image data is transmitted.

In a case where the scan instruction received by the image processing apparatus is a scan instruction not from a locally connected PC but from a cloud server, the transmitted image data is uploaded on the cloud. In this case, if the image processing apparatus is set so as not to require the user's operation on the image processing apparatus to receive a scan instruction and perform scanning, there is a possibility that image data of an unintended document may be uploaded on the cloud.

### SUMMARY

The present disclosure is directed to a technique of preventing, in a case where a document is scanned and the generated image data is uploaded on the cloud, the image data of the document not intended by a user from being uploaded.

According to an aspect of the present disclosure, an image processing apparatus includes a reception unit configured to receive a scan instruction, an acceptance unit configured to accept an instruction from a user, a scan unit configured to scan a document based on the scan instruction to generate image data, a transmission unit configured to transmit the generated image data, a setting unit configured to enable a setting requiring that the acceptance unit accepts the instruction from the user to scan the document by the scan unit based on the scan instruction, a registration unit configured to perform registration processing for the transmission unit to transmit the generated image data to a cloud server, and a display unit configured to display information for urging the user to enable the setting based on that the registration processing is performed.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration according to an exemplary embodiment.

FIG. 2 is a block diagram illustrating a configuration of a multifunction peripheral (MFP).

FIG. 3 is a block diagram illustrating a configuration of an information processing terminal.

FIG. 4 is a flowchart illustrating a procedure of registration processing by the MFP.

FIG. 5 is a flowchart illustrating a procedure of registration processing by an application server.

FIG. 6 is a sequence diagram illustrating a flow of the registration processing.

FIG. 7 is a diagram illustrating example screens for the registration processing.

FIG. 8 is a sequence diagram illustrating a flow of scan processing.

FIG. 9 is a diagram illustrating example screens of manually shifting to an online state.

FIG. 10 is a diagram illustrating example screens for executing scan processing on the information processing terminal.

FIG. 11 is a sequence diagram illustrating a flow of registration processing.

FIG. 12 is a diagram illustrating example screens for the registration processing.

FIG. 13 is a flowchart illustrating a procedure of automatic online function processing.

FIG. 14 is a block diagram illustrating a configuration of the application server.

### DESCRIPTION OF THE EMBODIMENTS

Hereinbelow, exemplary embodiments of the present disclosure will be described with reference to the attached drawings. Configurations described in the following exemplary embodiments are merely examples, and the present disclosure is not limited to the exemplary embodiments.

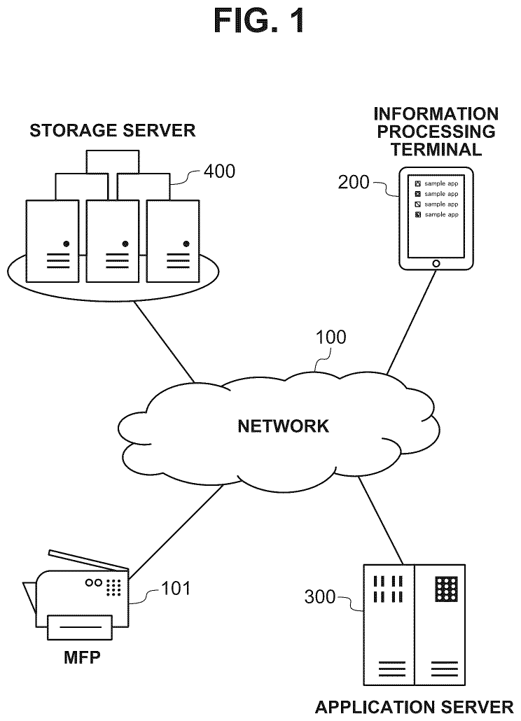

A first exemplary embodiment will be described. FIG. 1 is a diagram illustrating an example of a system configuration according to the present exemplary embodiment. The system configuration according to the present exemplary embodiment is an example of a cloud scan system, and has a configuration in which an application server 300, a storage server 400, a multifunction peripheral (MFP) 101, and an information processing terminal 200 are connected via a network 100. The MFP 101 is not limited to an MFP serving as an image processing apparatus having a print function and a facsimile (FAX) function in addition to a reading function, and may be a reading apparatus having a reading function and a communication function. The application server 300 is a cloud server, which displays a user interface (UI) screen on a screen of the information processing terminal 200, generates a scan job in response to an input onto the UI screen, transmits a scan request to the MFP 101, and acquires image data. The network 100 according to the present exemplary embodiment may be the Internet or a Local Area Network (LAN). The network 100 may be a wired network or a wireless network.

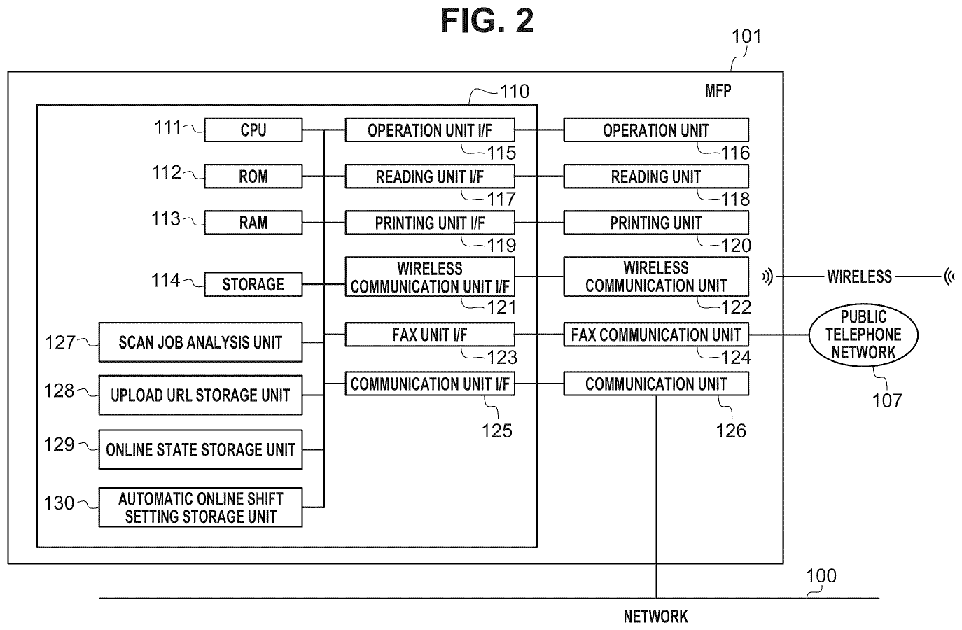

FIG. 2 is a diagram illustrating an example of a hardware configuration of the MFP 101. The MFP 101 includes a central processing unit (CPU) 111, a read only memory (ROM) 112, a random access memory (RAM) 113, a storage 114, an operation unit interface (I/F) 115, an operation unit (a user interface) 116, a reading unit I/F 117, a reading unit 118, a printing unit I/F 119, a printing unit 120, a wireless communication unit I/F 121, and a wireless communication unit 122. The MFP 101 further includes a FAX unit I/F 123, a FAX communication unit 124, a communication unit I/F 125, a communication unit 126, a scan job analysis unit 127, an upload Uniform Resource Locator (URL) storage unit 128, an online state storage unit 129, and an automatic online shift setting storage unit 130. A control unit 110 including the CPU 111 controls operations of the entire MFP 101. The CPU 111 loads a control program stored in the ROM 112 or the storage 114 into the RAM 113 to execute various controls such as a reading control and a print control. The ROM 112 stores control programs executable by the CPU 111. The ROM 112 also stores a boot program and font data. The RAM 113 is a main memory used as a work area, and a temporary storage area for loading various kinds of control programs stored in the ROM 112 and the storage 114. The storage 114 stores image data, print data, various kinds of programs, and various kinds of setting information. In the present exemplary embodiment, a flash memory is used as the storage 114, but an auxiliary memory device, such as a solid state drive (SSD) and a hard disc drive (HDD), may be used. An embedded Multi Media Card (eMMC) may also be used. The MFP 101 according to the present exemplary embodiment is assumed to execute processing illustrated in each flowchart described below by one CPU (CPU 111) using one memory (RAM 113), but it is not limited to the exemplary embodiment. For example, the processing illustrated in each flowchart described below can be executed by a plurality of CPUs, RAMs, ROMs, and storages, operating in cooperation. A hardware circuit, such as an application specific integrated circuit (ASIC) and a field programmable gate array (FPGA), may be used to execute part of the processing. The operation unit I/F 115 connects the operation unit 116 including a display unit, such as a touch panel, and hard keys, with the control unit 110. The operation unit 116 displays information to a user, and receives instructions from the user. The reading unit I/F 117 connects the reading unit 118, such as a scanner, with the control unit 110. The reading unit 118 scans an image of a document, and the CPU 111 generates image data. The image data generated based on the image read by the reading unit 118 is transmitted to an external apparatus, or printed on a recording sheet. The reading unit 118 includes an automatic document feeder (ADF), and can generate image data by conveying a document placed on a document tray provided in the MFP 101, and reading an image of the conveyed document. The printing unit I/F 119 connects the printing unit 120, such as a printer, with the control unit 110. The CPU 111 transfers image data (print data) stored in the RAM 113 to the printing unit 120 via the printing unit I/F 119. The printing unit 120 prints an image based on the transferred image data on a recording sheet fed from a sheet feed cassette. The wireless communication unit I/F 121 is an interface for controlling the wireless communication unit 122, and can wirelessly connect the control unit 110 and an external wireless device. The control unit 110 is connected to a public telephone network 107 by controlling the FAX communication unit 124, such as a facsimile machine, by the FAX unit I/F 123. The FAX unit I/F 123 is an interface for controlling the FAX communication unit 124, and can connect to the public telephone network 107 by controlling a modem for the facsimile communication or a network control unit (NCU), and can perform a facsimile communication protocol control. The communication unit I/F 125 connects the control unit 110 and the network 100. The communication unit I/F 125 is used by the communication unit 126 to transmit image data and various kinds of information in the MFP 101 to an external apparatus on the network 100, and to receive print data from an information processing apparatus on the network 100, and information on the network 100. Examples of a transmission/reception method via the network 100 include a transmission/reception using an electronic mail (e-mail), and a file transmission/reception using another protocol such as File Transfer Protocol (FTP), Server Message Block (SMB), and Web-based Distributed Authoring and Versioning (WEBDAV). By an access through a HyperText Transfer Protocol (HTTP) communication from the application server 300, scan jobs and various kinds of setting data can be transmitted and received via the network 100. The CPU 111 receives a scan job from the application server 300 connected via the network 100, and analyzes the received scan job using the scan job analysis unit 127. The upload URL for uploading the read image data included in the analysis result to the application server 300 is stored in the upload URL storage unit 128. Other scan parameters (e.g., document type such as a document, and reading size such as A4) are stored in a work area of the RAM 113. The online state storage unit 129 stores information indicating whether the MFP 101 is in an online state. The automatic online shift setting storage unit 130 stores a setting about whether to perform an automatic offline shift operation.

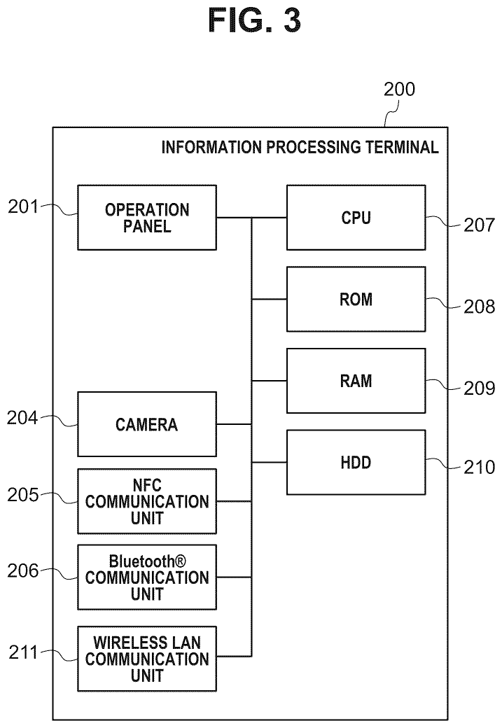

FIG. 3 is a block diagram illustrating an example of a hardware configuration of the information processing terminal 200. The information processing terminal 200 according to the present exemplary embodiment is assumed to be a device such as a smartphone, a tablet PC, and a PC, but any other devices (information processing apparatuses) can be used as long as the devices can communicate with the MFP 101. A CPU 207 loads a program stored in a ROM 208 into a RAM 209 and executes the loaded program to perform various kinds of processing for controlling operations of the information processing terminal 200. The ROM 208 stores a control program. The RAM 209 is used as a main memory for the CPU 207 and a temporary storage area such as a work area. An HDD 210 stores various kinds of data such as pictures and digital documents. An operation panel 201 is provided with a touch panel function capable of detecting user's touch operations, and displays various kinds of screens provided by an operating system (OS) or an e-mail transmission application. The operation panel 201 is used to execute a setup tool serving as an initial setting application of the MFP 101. A user can input a desired operation instruction to the information processing terminal 200, by performing a touch operation on the operation panel 201. The information processing terminal 200 may be provided with hardware keys (not illustrated), and a user may input the operation instructions to the information processing terminal 200 using the hardware keys. A camera 204 captures an image in response to a user's image capturing instruction. The picture captured by the camera 204 is stored in a predetermined area of the HDD 210. Information can be acquired from a quick response code (QR Code®) read by the camera 204 using a program that can analyze the QR Code®. The information processing terminal 200 can transmit and receive data to and from various types of peripheral devices via a Near Field Communication (NFC) communication unit 205, a Bluetooth® communication unit 206, or a wireless LAN communication unit 211. The Bluetooth® communication unit 206 of the information processing terminal 200 may support the Bluetooth® Low Energy. A setup tool for the MFP 101 is installed (saved) in a predetermined area of the HDD 210, and is executed by loading the setup tool in the RAM 209.

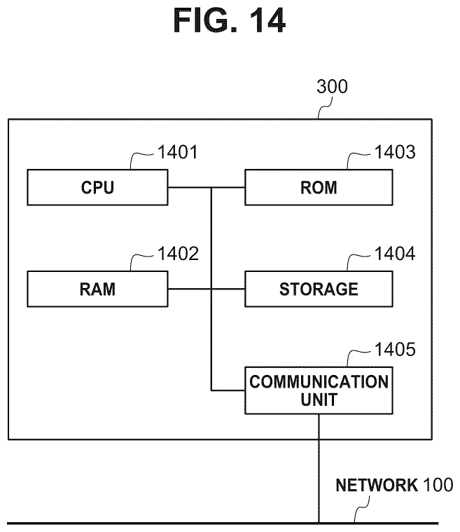

FIG. 14 is a block diagram illustrating an example of a hardware configuration of the application server 300. The application server 300 serving as a cloud server includes a CPU 1401, a RAM 1402, a ROM 1403, a storage 1404, and a communication unit 1405. The CPU 1401 performs various kinds of controls such as a communication control with another connected server, by loading a control program stored in the ROM 1403 or the storage 1404 into the RAM 1402, and executing the loaded program. The application server 300 according to the present exemplary embodiment may include one apparatus, or a plurality of apparatuses. The ROM 1403 stores control programs executable by the CPU 1401. The ROM 1403 also stores a boot program or the like. The RAM 1402 is a main memory used as a work area, and a temporary storage area for loading various kinds of control programs stored in the ROM 1403 and the storage 1404. The storage 1404 stores image data, various kinds of programs, and various kinds of setting information. In the present exemplary embodiment, a flash memory is used as the storage 1404, but an auxiliary memory device, such as an SSD and an HDD, may be used. An eMMC may also be used. The communication unit 1405 is connected to the network 100, and controlled by the CPU 1401 to perform communications with a mobile terminal or another connected server. The storage server 400 has a similar configuration to the application server 300 in FIG. 14, and the description thereof is omitted. Each server may be a virtual server operating in one hardware configuration.

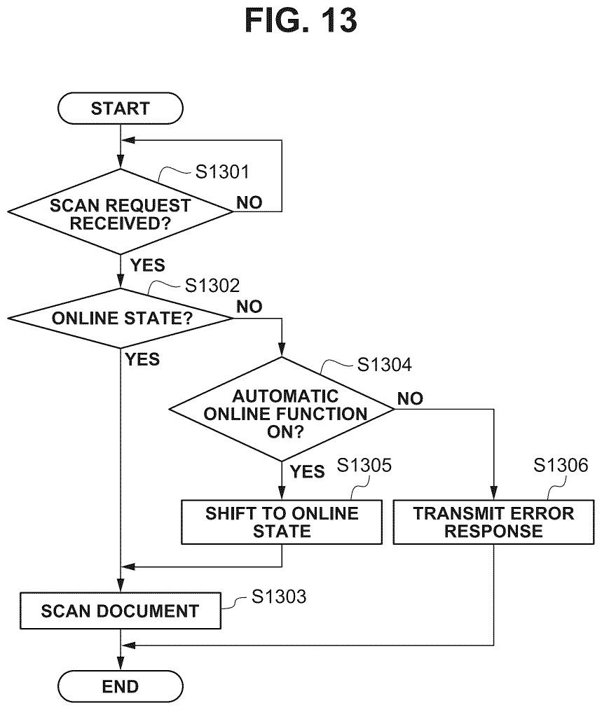

FIG. 13 is a flowchart illustrating a procedure of online determination processing including an automatic online shift function of the MFP 101. Before describing the flowchart, the automatic online shift function, an offline state, and an online state of the MFP 101 will be described.

The offline state is a state where a read image can be stored in a storage device (not illustrated) such as the storage 114 in the MFP 101 or a universal serial bus (USB) memory connected to the MFP 101. In other words, the offline state is a state where the reading unit 118 is set not to scan a document, even if the MFP 101 receives a scan instruction from a PC or a cloud server. In the offline state, the reception of a scan request via the network 100 to be described in the present exemplary embodiment is prohibited.

The online state is a state where the reading unit 118 is set to scan a document based on the scan instruction when the MFP 101 receives a scan instruction from a PC or a cloud server. In the online state, the MFP 101 can receive a scan request (scan instruction) via the network 100 described in the present exemplary embodiment, but is prohibited from storing the image data in the storage 114 and the USB memory not using the network 100.

The automatic online function is a function for enabling the scan request via the network 100 by automatically shifting to the online state in a case where a scan instruction via the network 100 is received in the offline state. In other words, the automatic online function is a function that does not require receiving a user's instruction for scanning a document based on a scan instruction. The shift from the online state to the offline state may be performed automatically based on a predetermined time, or may be performed only manually.

In a case where the automatic online function is not set, the MFP 101 does not shift from the offline state to the online state until a user's instruction is given to the MFP 101. In other words, when the automatic online function is not set, a setting that requires receiving the user's instruction for scanning a document based on a scan instruction is enabled.

In step S1301, the CPU 111 determines whether the communication unit 126 receives a scan request via the network 100. In a case where the communication unit 126 does not receive a scan request (NO in step S1301), the processing in step S1301 is repeated to wait for receiving a scan request. In a case where the communication unit 126 receives a scan request (YES in step S1301), the processing proceeds to step S1302. In step S1302, the CPU 111 refers to the content of the online state storage unit 129, and determines whether the MFP 101 is in an online state. In a case where the CPU 111 determines that the MFP 101 is in an online state (YES in step S1302), the processing proceeds to step S1303. In step S1303, the reading unit 118 scans the document to generate image data based on the received scan request (instruction), and transmits the generated image data to the scan request transmission source. Then, the processing ends. In step S1302, in a case where the CPU 111 determines that the MFP 101 is in an offline state (NO in step S1302), the processing proceeds to step S1304. In step S1304, the CPU 111 refers to the content of the automatic online shift setting storage unit 130 to determine whether the automatic online function is ON. In a case where the CPU 111 determines that the automatic online function is ON (YES in step S1304), the processing proceeds to step S1305. In step S1305, the CPU 111 changes the content of the online state storage unit 129 from the offline to the online. Then, the processing proceeds to step S1303.

In step S1304, in a case where the CPU 111 determines that the automatic online function is OFF (NO in step S1304), the processing proceeds to step S1306. In step S1306, the CPU 111 transmits information indicating an error to the transmission source of the scan request. Then, the processing ends. In this way, it is possible to prevent the remote scan from being executed in the offline state.

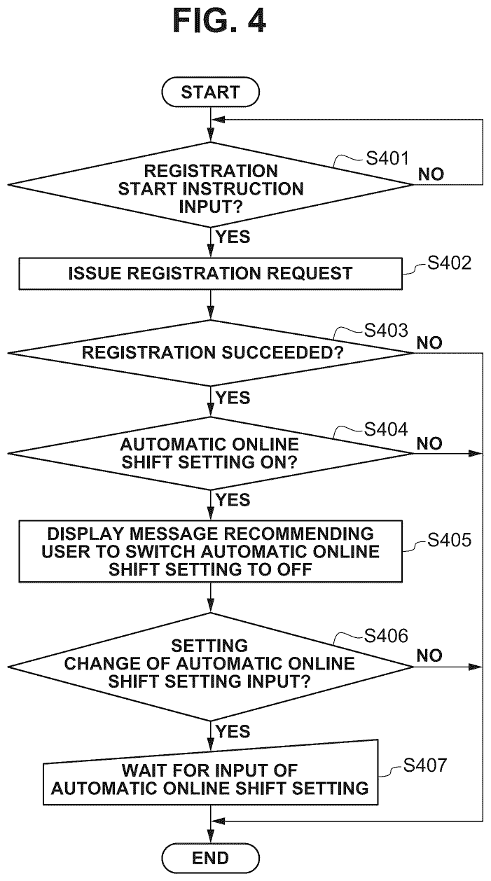

FIG. 4 is a flowchart illustrating a procedure of registration processing to the cloud scan system. The flowchart in FIG. 4 is implemented when the CPU 111 of the MFP 101 loads a program into the RAM 113 and executes the loaded program. The flowchart in FIG. 4 starts when a screen for the registration processing is displayed. The registration processing in FIG. 4 is registration processing for transmitting the image data generated by scan processing to the application server 300.

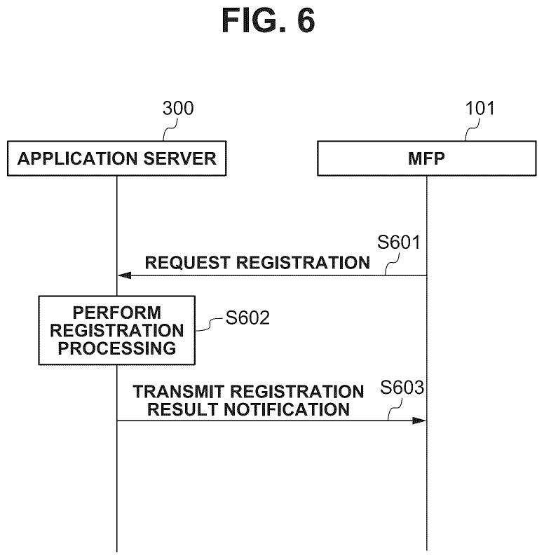

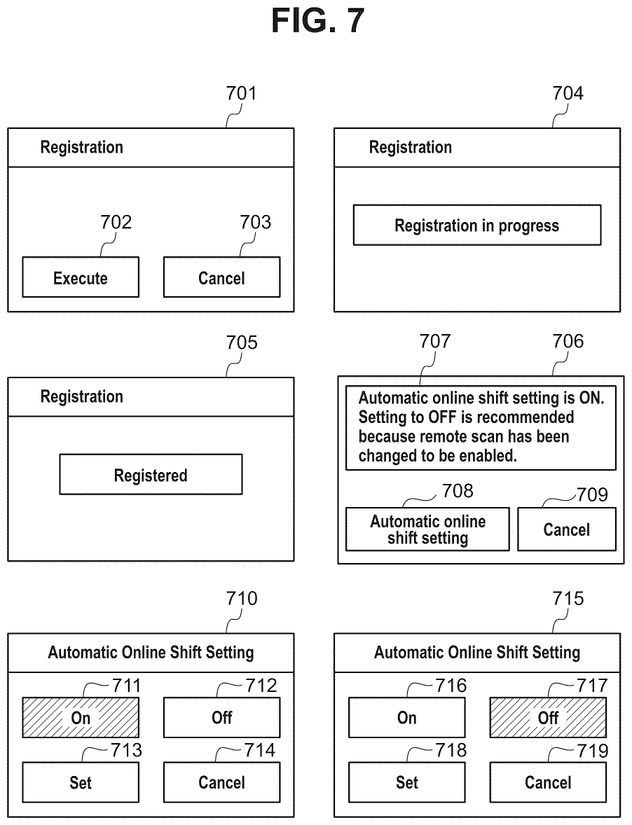

In step S401, the CPU 111 determines whether a registration start instruction is input. An example of a screen displayed on the operation unit 116 in this state is a screen 701 in FIG. 7. The CPU 111 waits for the execution button 702 being pressed. In step S401, in a case where the execution button 702 is pressed (YES in step S401), the processing proceeds to step S402. In step S402, the CPU 111 issues a registration request in step S601 of FIG. 6 to the application server 300, and then the processing proceeds to step S403. In the processing in step S601, identification information such as a serial number of the MFP 101 is transmitted.

In step S403, the CPU 111 waits for a registration result notification in step S603 of FIG. 6 from the application server 300. In a case where the content of the notification is a “registration succeeded” (YES in step S403), the processing proceeds to step S404. In step S403, in a case where the CPU 111 determines that the registration has failed (NO in step S403), the CPU 111 ends the processing. In step S404, the CPU 111 refers to the automatic online shift setting storage unit 130 to determine the content of the automatic online shift setting. In a case where the automatic online shift setting is set ON (YES in step S404), the processing proceeds to step S405. In other words, in a case where the setting requiring the user's instruction to scan the document is not enabled, i.e., in a case where a user's instruction is not required for the shift from the offline state to the online state, the processing proceeds to step S405.

In step S404, in a case where the automatic online shift setting is set disabled (NO in step S404), the CPU 111 ends the processing. In other words, in a case where the setting that requires a user's instruction to scan a document is enabled, i.e., in a case where a user's instruction is required for the shift from the offline state to the online state, the CPU 111 ends the processing.

In step S405, the CPU 111 displays on the operation unit 116 a message recommending switching the automatic online shift setting to OFF. An example of a screen displayed on the operation unit 116 in this state is a screen 706 in FIG. 7. On the screen 706, a message 707 indicating that the automatic online shift setting is ON, and a message recommending (urging) setting the automatic online shift setting to be disabled is displayed. In other words, a message indicating that the setting that requires receiving a user's instruction for scanning a document is not enabled (i.e., disabled) is displayed. The message 707 recommending (urging) enabling the setting that requires receiving a user's instruction for scanning a document is displayed.

In step S406, the CPU 111 waits for the setting change of the automatic online shift setting being input. In a case where a setting button 708 on the screen 706 in FIG. 7 is pressed (YES in step S406), a screen 710 in FIG. 7 is displayed on the operation unit 116, and the processing proceeds to step S407. In step S406, in a case where a cancel button 709 on the screen 706 is pressed (NO in step S406), the CPU 111 ends the processing. In step S407, the CPU 111 displays the screen 710 and waits for input. In a case where an off button 712 on the screen 710 is pressed, the CPU 111 displays an automatic online shift setting screen 715 in FIG. 7, and waits for input. In a case where the CPU 111 determines that a setting button 718 on the automatic online shift setting screen 715 or a setting button 713 on the screen 710 is pressed, the CPU 111 updates the content of the automatic online shift setting storage unit 130 in accordance with the content of the pressed button, and ends the processing.

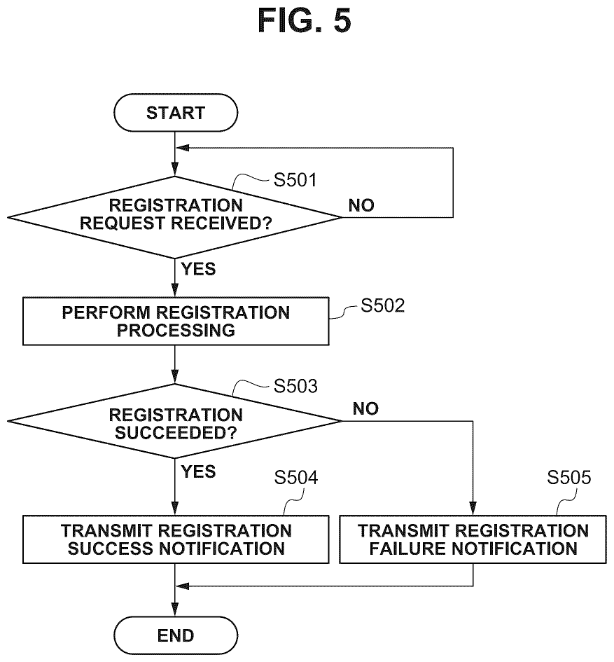

FIG. 5 is a flowchart illustrating a procedure of registration processing to the cloud scan system. The flowchart in FIG. 5 is implemented by the CPU 1401 of the application server 300 loading a program stored in the ROM 1403 into the RAM 1402, and executing the loaded program. The flowchart in FIG. 5 starts when the application server 300 is activated.

In step S501, the CPU 1401 waits for a registration request from the MFP 101 in step S601 of FIG. 6. In a case where the CPU 1401 receives the registration request in step S601 (YES in step S501), the processing proceeds to step S502. In step S502, the CPU 1401 analyzes the content of the registration request in step S601, and performs the registration processing. Then, the processing proceeds to step S503. In step S503, the CPU 1401 determines the registration processing result. In a case where the registration has succeeded (YES in step S503), the processing proceeds to step S504. In step S504, the CPU 1401 transmits a registration success notification as the registration result notification in step S603 of FIG. 6, and ends the processing. In a case where the registration has failed (NO in step S503), the processing proceeds to step S505. In step S505, the CPU 1401 transmits a registration failure notification as the registration result notification in step S603 of FIG. 6, and ends the processing.

By the registration processing being executed, the MFP 101 can be registered as a candidate for a transmission destination to transmit a scan instruction thereto. The application server 300 can identify capability information about the MFP 101 based on the serial number received from the MFP 101. By using the identified capability information, it is possible to present a candidate for the scan setting on the UI screen of the information processing terminal 200.

FIG. 6 is a sequence diagram illustrating a flow of the registration processing. As described above with reference to FIGS. 4 and 5, the registration processing in step S602 is performed when the application server 300 receives the registration request in step S601 from the MFP 101. The notification of the result of the registration processing in step S602 is provided to the MFP 101 as the registration result notification in step S603.

FIG. 7 is a diagram illustrating examples of screens displayed on the operation unit 116 in the registration processing of the MFP 101. The screen 701 is displayed in a registration execution wait state. A registration in progress screen 704 is an example of a screen displayed after the registration request in step S402 of FIG. 4. A registration completed screen 705 is an example of a screen displayed after the registration result notification in step S603 of FIG. 6 is received. The screen 706 is an example of a screen displayed in step S405 of FIG. 4. The screen 710 and the automatic online shift setting screen 715 are examples displayed in step S407 of FIG. 4.

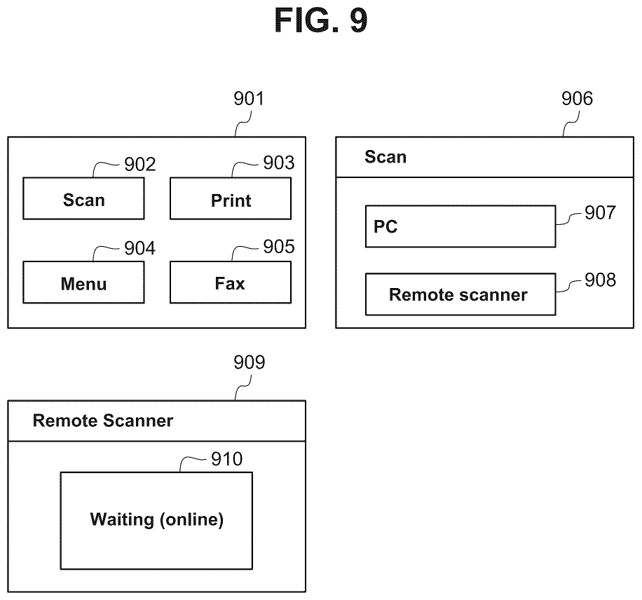

FIG. 9 is a diagram illustrating examples of screens displayed on the operation unit 116 when the MFP 101 is manually operated to shift to the online state. A home screen 901 is an example of a home screen displayed in a state where the MFP 101 is not operated or the like after powered on. The home screen 901 displays function buttons, which can be selected by being pressed. In a case where the CPU 111 determines that a scan button 902 is pressed, a setting screen of the scan function is displayed. In a similar manner, in a case where a print button 903, a menu button 904, a FAX button 905 are pressed, a print function setting screen, a menu screen, a FAX function setting screen are displayed, respectively. A scan function setting screen 906 is an example of a screen displayed in a case where the scan button 902 is pressed. A PC selection button 907 is a button for selecting a PC to be a target of a push scan in which a PC is designated as a transmission destination of the image data from the MFP 101 to perform scanning. A remote scanner button 908 is a button for shifting the MFP 101 to the online state, to enable a remote scan function. When the remote scanner button 908 is selected before the MFP 101 receives a scan instruction from the application server 300 or a PC, the MFP 101 can execute the remote scan. In a case where the remote scanner button 908 is not selected before the MFP 101 receives a scan instruction from the application server 300 or a PC, the MFP 101 cannot execute the remote scan. A remote scanner screen 909 is an example of a screen indicating that the MFP 101 is in an online state allowing the remote scan to be executed. The state where the remote scanner screen 909 is displayed is a state where the MFP 101 has received the user's instruction for scan based on the scan instruction received from the application server 300.

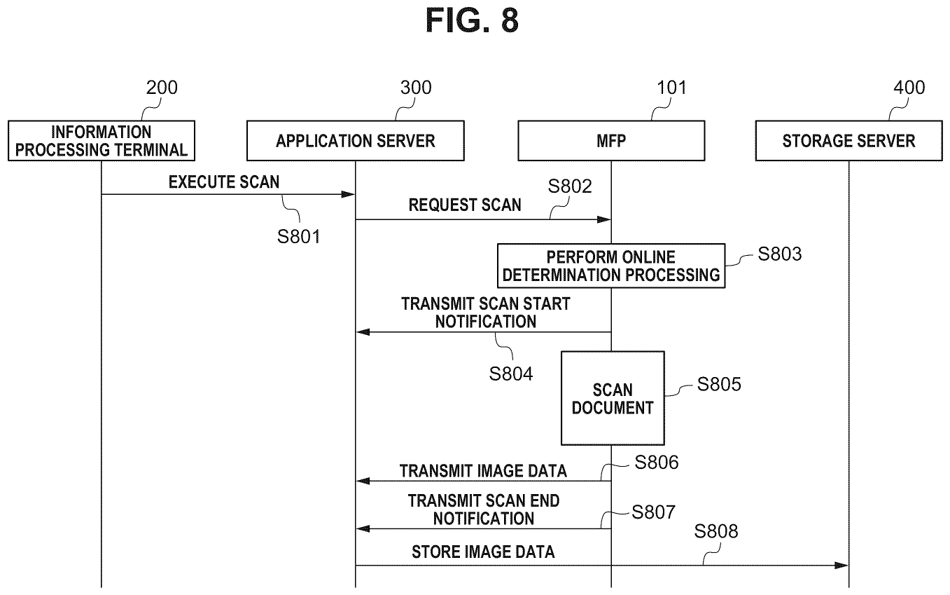

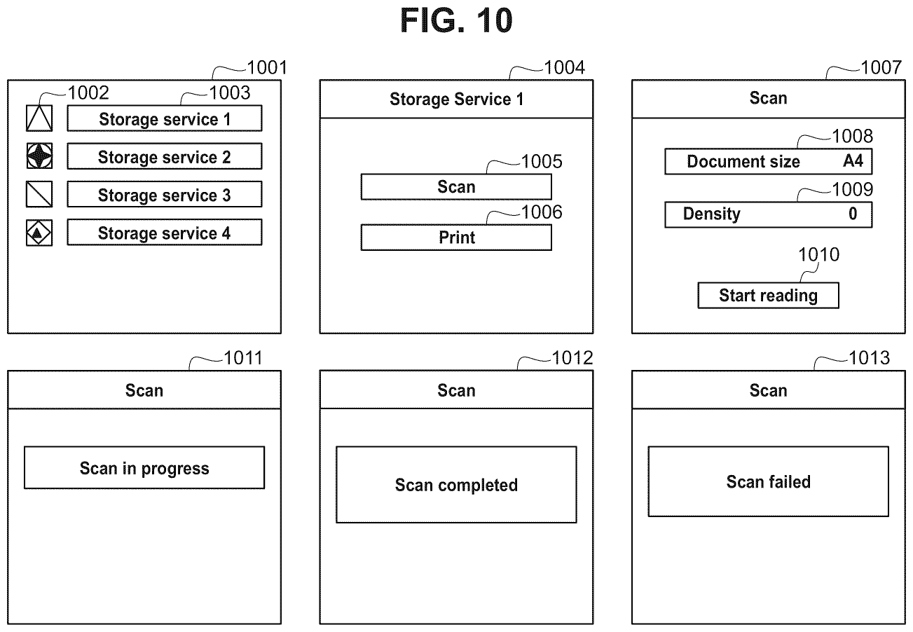

FIG. 8 is a sequence diagram illustrating a flow of scan processing executed in the cloud scan system. When a storage service icon 1002 or a storage service name 1003 is selected on a home screen 1001 in FIG. 10, the CPU 207 of the information processing terminal 200 determines the corresponding storage server 400 and displays a storage service function selection screen 1004. The CPU 207 of the information processing terminal 200 displays a scan function screen 1007 when a scan button 1005 is pressed. When a reading start button 1010 is pressed, in step S801, the CPU 207 of the information processing terminal 200 notifies the application server 300 of a scan execution notification. Upon receiving the scan execution notification in step S801, in step S802, the application server 300 transmits a scan request to the MFP 101. Upon receiving the scan request in step S802, in step S803, the CPU 111 of the MFP 101 performs online determination processing to determine whether the scan request is executable. Since the content of the online determination processing in step S803 is described in the description of FIG. 13, the description thereof is omitted. In the present exemplary embodiment, assuming that the user has set the automatic online shift setting to OFF, because the display of the registration processing recommends setting the automatic online shift setting to OFF. In a case where the automatic online shift setting is set to OFF, it is required to start reading after pressing the scan button 902 on the home screen 901, and pressing the remote scanner button 908 on the scan function setting screen 906 to shift the screen to the remote scanner screen 909. In a case where the scan is executable, in step S804, the MFP 101 transmits a scan start notification to the application server 300, and in step S805, the MFP 101 executes a document scan. In step S806, the CPU 111 of the MFP 101 uploads image data acquired by the document scan in step S805, and in step S807, transmits a scan end notification, to the application server 300. Upon receiving the scan end notification in step S807, in step S808, the application server 300 transfers the image data uploaded from the MFP 101 to the storage server 400. Then, the processing ends.

FIG. 9 is a diagram illustrating examples of screens displayed on the operation unit 116 when the MFP 101 is manually operated to shift to the online state. The home screen 901 is an example of a home screen displayed in a state where the MFP 101 is not operated or the like after powered on. The home screen 901 displays function buttons, which can be selected by being pressed. In a case where the CPU 111 determines that the scan button 902 is pressed, the CPU 111 displays a screen related to the scan button 902. In a similar manner, in a case where the CPU 111 determines that the print button 903, the menu button 904, and the FAX button 905 are pressed, a print function related screen, a menu function related screen, and a FAX function related screen are displayed, respectively. The scan function setting screen 906 is an example of a screen displayed in a case where the scan button 902 is pressed. The PC selection button 907 is a button for selecting a PC to be a target of a push scan in which a PC is designated from the MFP 101 to perform scanning. The remote scanner button 908 is a button for shifting the MFP 101 to the online state, to enable a remote scan function. The remote scanner screen 909 is an example of a screen indicating that the MFP 101 is in an online state allowing the remote scan to be executed.

FIG. 10 is a diagram illustrating examples of scan execution screens displayed on the operation panel 201 of the information processing terminal 200. The home screen 1001 is an example of a screen in a state where a home screen of the cloud scan system is displayed on a browser. The storage service icon 1002 is an example of a storage service icon, and a user can select a storage service by pressing the storage service icon 1002. The storage service name 1003 is an example of a storage service name, and a user can select a storage service by pressing the storage service name 1003 in a similar manner to the storage service icon 1002. The home screen 1001 is an example of a screen on which four types of storage icons and four types of storage names are displayed. The storage service function selection screen 1004 is an example of a screen in a state where a storage service is selected by pressing the storage service icon 1002 or the storage service name 1003. The scan button 1005 is an example of a function selection button to select the scan function by pressing it, and the screen of the information processing terminal 200 can shift to a scan function setting screen. A print button 1006 is an example of a function selection button to select a print function by pressing it, and the screen of the information processing terminal 200 can shift to a print function setting screen. The scan function screen 1007 is an example of a scan function setting screen to be displayed by pressing the scan button 1005. A document size designation button 1008 is an example of a document size designation button to shift the screen to a screen for selecting a read document size by pressing it. A density designation button 1009 is an example of a density designation button to shift the screen to a screen for selecting a density designation by pressing it. The reading start button 1010 is an example of a reading start button to instruct the document reading by pressing it. A scan in progress screen 1011 is an example of a screen displayed in a case where a reading processing request is performed by pressing the reading start button 1010. A scan completed screen 1012 is an example of a screen displayed in a case where the reading processing request performed by pressing the reading start button 1010 has been completed normally. A scan failure screen 1013 is an example of a screen displayed in a case where the reading processing request performed by pressing the reading start button 1010 has failed.

In the above-described processing, the description is given of the example of urging the user to enable the setting that requires receiving the user's instruction to scan the document based on the scan instruction, by executing the registration processing to transmit the image data generated by the scanning to the cloud server.

However, the present exemplary embodiment is not limited to the exemplary embodiment. The automatic online shift setting is set to be automatically disabled by executing the above-described registration processing, and the notification that the setting is performed may be provided to the user. In this way, by performing the above-described registration processing, it is possible to automatically enable the setting that requires receiving a user's instruction for scanning a document based on a scan instruction.

By executing the above-described processing, it is possible prevent image data of a document not intended by a user from being uploaded in a case where a document is scanned to upload the generated image data onto the cloud.

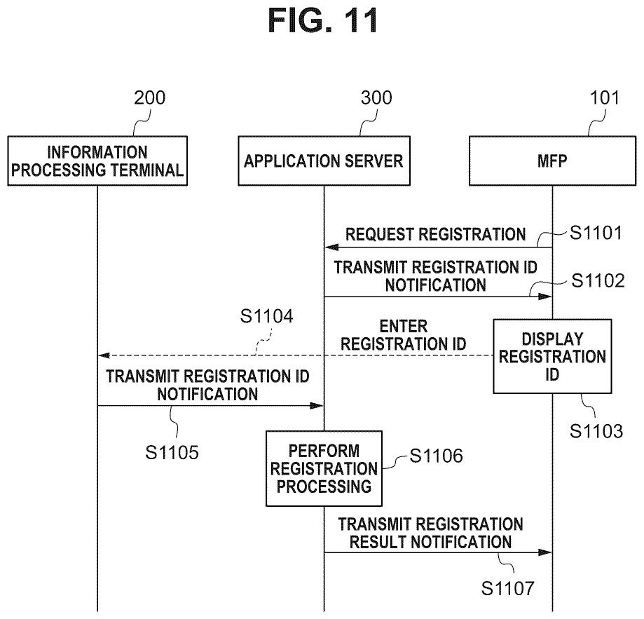

Next, a second exemplary embodiment will be described. The second exemplary embodiment is an embodiment obtained by replacing the registration request in step S402 of FIG. 4 with a sequence in FIG. 11.

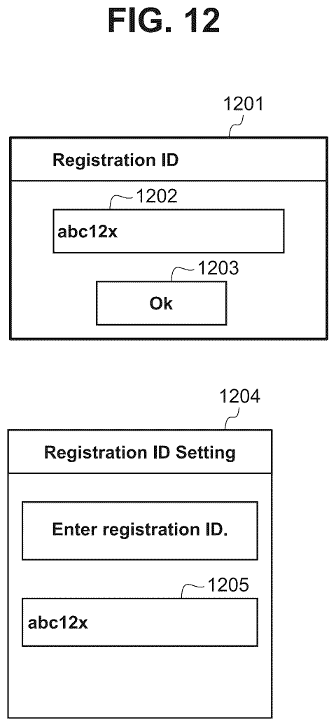

FIG. 12 is an example of a screen for the registration processing. A registration identification (ID) display screen 1201 is an example of a registration ID display screen displayed on the operation unit 116 of the MFP 101 when the MFP 101 receives a registration ID notification in step S1102 from the application server 300. A registration ID 1202 is displayed by analyzing the content included in the received registration ID notification in step S1102. The next screen is display by pressing an OK button 1203. A registration ID setting screen 1204 is an example of a registration ID setting screen displayed on the operation panel 201 of the information processing terminal 200. A registration ID is entered by a user in a registration ID entry field 1205.

FIG. 11 is a sequence diagram illustrating a flow of registration processing. In a similar manner to the first exemplary embodiment, in a case where the execution button 702 is pressed in a state where the screen 701 is displayed on the operation unit 116 of the MFP 101, in step S1101, the CPU 111 transmits a notification of a registration request to the application server 300, and displays the registration in progress screen 704. Upon receiving the registration request in step S1101, the CPU 1401 of the application server 300 generates a registration ID for the registration processing, and in step S1102, transmits the registration ID notification to the MFP 101. Upon receiving the registration ID notification in step S1102, the CPU 111 of the MFP 101 analyzes the registration ID notification received in step S1102, and in step S1103, the CPU 111 displays the registration ID display screen 1201. A user refers to the registration ID 1202 displayed in step S1103, and in step S1104, enters the registration ID in the registration ID entry field 1205 of the registration ID setting screen 1204 displayed on the operation panel 201 of the information processing terminal 200. In a case where the CPU 207 of the information processing terminal 200 determines that the entry in the registration ID entry field 1205 has been completed, the CPU 207 of the information processing terminal 200 transmits a registration ID notification to the application server 300 in step S1105. Upon receiving the registration ID notification in step S1105, the application server 300 executes registration processing in step S1106. When the execution of the registration processing in step S1106 has been completed, the application server 300 transmits the registration result notification to the MFP 101 in step S1107. From this point, operations are the same as those in step S403 and the subsequent steps in FIG. 4, and the descriptions thereof are omitted.

As described above, in the case where the automatic online shift setting is ON after the registration to the cloud scan system, the MFP 101 recommends the user to set the automatic online shift setting to OFF. By setting the automatic online shift setting to OFF, the document reading time can be restricted in the online state, and an effect of enabling a secure document reading is obtained by reducing risks of a document being read by a third person.

In a case where the MFP 101 has a registration function of a system administrator who manages the settings and the like, if a system administrator is registered, the MFP 101 determines that there are many users who use the MFP 101, and a display for recommending a user to set the automatic online shift setting to OFF may be performed.

Even in the case where the MFP 101 has the registration function of the system administrator, if no system administrator is registered, the MFP 101 determines that there are not many users who use the MFP 101, and a display for recommending a user to set the automatic online shift setting to ON may be performed.

In a case where the automatic online shift setting is ON after the registration to the cloud scan system, the automatic online shift setting may be automatically set to OFF before the notification to the user, and then the MFP 101 may notify the user of the setting change to cause the user to set the automatic online shift setting to OFF with a high probability.

In a case where the MFP 101 has a configuration in which a plurality of product models is operated with one common program and a setting for each product model, a display for recommending a user to set the automatic online shift setting to OFF may be performed, if the configuration can be determined to be a model estimated to be used by many users.

According to the exemplary embodiments, in a case where a document is scanned and the image data is uploaded to the cloud, it is possible to prevent the image data of the document not intended by a user from being uploaded.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-134577, filed Aug. 22, 2023, which is hereby incorporated by reference herein in its entirety.

What is claimed is:

1. An image processing apparatus comprising:
a user interface that accepts an operation by a user;
a communicator that receives a scan instruction;
a scanner that scans a document based on the scan instruction to generate image data,
wherein the communicator transmits the generated image data;
one or more controllers including one or more processors and one or more memories, the one or more controllers is configured to:
enable a setting requiring the operation by the user to cause the document to be scanned based on the scan instruction;
perform registration processing to register the image processing apparats to transmit the generated image data to a cloud server; and
wherein the user interface displays information that urges the user to enable the setting when the registration processing is being performed.

2. The image processing apparatus according to claim 1,
wherein the user interface displays the information that uses the user to enable the setting based on that the registration processing being performed in a state where the setting is not previously enabled, and
wherein the user interface does not display the information that urges the user to enable the setting even when the registration processing is being performed in a state where the setting is previously enabled.

3. The image processing apparatus according to claim 1, wherein the communicator receives the scan instruction from the cloud server.

4. The image processing apparatus according to claim 1,
wherein, in the registration processing, processing to transmit identification information about the image processing apparatus to the cloud server is performed, and
wherein the image processing apparatus is registered as a candidate for a transmission destination of the scan instruction by the identification information being transmitted to the cloud server.

5. The image processing apparatus according to claim 1, wherein the information for urging the user to enable the setting is a message to urge the user to enable the setting.

6. An image processing method comprising:
receiving a scan instruction;
accepting an operation by a user;
scanning a document based on the scan instruction to generate image data;
transmitting the generated image data;
enabling a setting that requires accepting the operation by the user in the accepting for causing the document to be scanned based on the scan instruction in the scanning;
performing registration processing to register the image processing apparats for transmitting the generated image data to a cloud server in the transmitting; and
displaying information that urges the user to enable the setting when the registration processing is being performed.

7. The image processing method according to claim 6,
wherein the information that uses the user to enable the setting is displayed in the displaying, based on that the registration processing is being performed in a state where the setting is not previously enabled, and
wherein the information that urges the user to enable the setting is not displayed in the displaying, even when the registration processing is being performed in a state where the setting is previously enabled.

8. The image processing method according to claim 6, wherein the scan instruction is received from the cloud server in the receiving.

9. The image processing method according to claim 6,
wherein, in the registration processing, processing to transmit identification information about an image processing apparatus to the cloud server is performed, and
wherein the image processing apparatus is registered as a candidate for a transmission destination of the scan instruction by the identification information being transmitted.

10. The image processing method according to claim 6, wherein the information to urge the user to enable the setting is a message to urge the user to enable the setting.
